(19) United States
(12) Patent Application Publication
(10) Pub. No.: US 2025/0040481 A1
(43) Pub. Date: Feb. 6, 2025

(54) ROTARY CUTTER LEVELING SYSTEM

(71) Applicant: Deere & Company, Moline, IL (US)

(72) Inventors: Kellen B. HILL, Ottumwa, IA (US); Cesar A. RAMIREZ TREVINO, Monterrey (MX); Zachary R. SOPHER, Lynn Center, IL (US); Scott T. BARROW, Davenport, IA (US)

(73) Assignee: Deere & Company, Moline, IL (US)

(21) Appl. No.: 18/776,483

(22) Filed: Jul. 18, 2024

Related U.S. Application Data
(60) Provisional application No. 63/516,692, filed on Jul. 31, 2023.

(51) Int. Cl. A01D 34/82; A01D 34/66; A01D 34/74

(52) U.S. Cl. CPC A01D 34/82; A01D 34/66; A01D 34/74

(57) ABSTRACT

One or more techniques and/or systems are disclosed for leveling a rotary cutter that includes a center cutting portion, a first cutting wing pivotally coupled to the center cutting portion, a second cutting wing pivotally coupled to the center cutting portion, and an actuator system having a center leveling sub-system, a first wing leveling sub-system, and a second wing leveling sub-system. The actuator system is configured to synchronously adjust the height of the center cutting portion, the first cutting wing, and the second cutting wing. The first wing leveling sub-system is configured to adjust the height of the first cutting wing independent from the center cutting portion and the second cutting wing, and the second wing leveling sub-system is configured to adjust the height of the second cutting wing independent from the center cutting portion and the first cutting wing.

### CROSS-REFERENCE TO RELATED APPLICATION(S)

This application claims priority to U.S. Ser. No. 63/516,692, entitled ROTARY CUTTER LEVELING SYSTEM, filed Jul. 31, 2023, which is incorporated herein by reference.

### BACKGROUND

An agricultural rotary cutter is a heavy-duty cutting machine used in farming and land clearing operations to mow down and clear dense vegetation, small trees, crops, and crop remnants in fields or pastures. A rotary cutter can be substantially wide to efficiently cut large swaths, and is typically equipped with sharp rotating blades, usually mounted on a spinning drum, which efficiently cuts through thick grass, shrubs, crops stalks, etc. The cutter's sturdy design allows it to handle rough and uneven terrain, providing effective vegetation control, land maintenance, and land clearing services in agricultural settings.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for leveling an agricultural rotary cutter to efficiently clear large swaths of land while maintaining a consistent cut height across the rotary cutter.

In one implementation, a rotary cutter may comprise a leveling system for adjusting the height of the rotary cutter. The rotary cutter may further comprise a center cutting portion, a first cutting wing pivotally coupled to the center cutting portion, a second cutting wing pivotally coupled to the center cutting portion, and an actuator system. The actuator system may comprise a center leveling sub-system, a first wing leveling sub-system, and a second wing leveling sub-system. The respective leveling sub-systems may comprise an actuator having a first end pivotally coupled to the respective center cutting portion, first cutting wing, and second cutting wing, and a second end threadably received by a deck support system configured to operably engage a surface beneath the center cutting portion, first cutting wing, and second cutting wing. The respective leveling sub-systems may be configured such that adjusting a distance between the first end of the actuator and the deck support system may result in an adjustment to a height of the respective center cutting portion, first cutting wing and second cutting wing relative to the surface.

In another implementation, the actuator system may be configured to operably adjust the height of the center cutting portion, the first cutting wing, and the second cutting wing between a first raised position and a second lowered position such that the first cutting wing and the second cutting wing may move relative to the center cutting portion.

In yet another implementation, rotating the second end of the actuator of the first wing leveling sub-system may result in an adjustment to the height of the first cutting wing independent from the center cutting portion and the second cutting wing, and rotating the second end of the actuator of the second wing leveling sub-system may result in an adjustment to the height of the second cutting wing independent from the center cutting portion and the first cutting wing.

In a further implementation, the leveling system may further comprise a third cutting wing pivotally coupled to the first cutting wing, and a fourth cutting wing pivotally coupled to the second cutting wing.

In another implementation, the third cutting wing may be pivotally coupled to the first cutting wing at an end of the first cutting wing opposite the center cutting portion, and the fourth cutting wing may be pivotally coupled to the second cutting wing at an end of the second cutting wing opposite the center cutting portion.

In yet another implementation, the actuator system may further comprise a third wing leveling sub-system and a fourth wing leveling sub-system. The respective leveling sub-systems may comprise an actuator comprising a first end pivotally coupled to the respective third cutting wing and fourth cutting wing, and a second end threadably received by a deck support system that operably engages a surface beneath the third cutting wing and fourth cutting wing. The respective leveling sub-systems may be configured such that adjusting a distance between the first end of the actuator and the deck support system may result in an adjustment to a height of the respective third cutting wing and fourth cutting wing relative to the surface.

In another implementation, the center cutting portion, first cutting wing, and second cutting wing may further comprise a fulcrum about which the respective deck support system may pivot.

In a further implementation, the second end of the actuator of the respective leveling sub-systems may comprise a piston rod.

In yet another implementation, the respective deck support systems may comprise a clevis comprising a first end configured to threadably receive the second end of the respective actuator and a second end configured to be pivotally coupled to the respective deck support system.

In another implementation, the piston rod of the respective first and second wing leveling sub-systems may comprise external threading and the respective clevis may comprise an opening with complementary internal threading such that when the piston rod is engaged with the clevis and rotated, the piston rod may be translated with respect to the clevis.

In a further implementation, rotating the piston rod of the respective first and second wing leveling sub-system in a first direction may increase the distance between the first end of the actuator and the clevis, which may result in an increase in distance between the respective first wing and second wing and the surface.

In another implementation, the first and second wing leveling sub-systems may further comprise a fastener threadably coupled to the piston rod, and the fastener may be positioned on the piston rod proximate the clevis.

In yet another implementation, the piston rod may comprise a tool surface that may be sized and shaped to receive a tool that may be capable of rotating the piston rod with respect to the actuator.

In a further implementation, the actuator of the respective leveling sub-systems may comprise one or more of a hydraulic actuator, a pneumatic actuator, an electrical actuator, and an electromechanical actuator.

In another implementation, the respective leveling sub-systems may further comprise a suspension element.

In yet another implementation, the suspension element of the respective leveling sub-systems may be a foam urethane suspension element comprising a plurality of conjoined disks.

In another implementation, a rotary cutter may comprise a leveling system and may further comprise a center cutting portion comprising a first side and a second side, a first cutting wing pivotally coupled to the first side of the center cutting portion, and a second cutting wing pivotally coupled to the second side of the center cutting portion. The first cutting wing may comprise a first side opposite the center cutting portion, and the second cutting wing may comprise a first side opposite the center cutting portion.

In a further implementation, the piston rod of the respective wing leveling sub-systems may comprise external threading and the respective deck support system may comprise a clevis comprising an opening with complementary internal threading, such that when the piston rod is engaged with the clevis and rotated, the piston rod may be translated with respect to the clevis.

In another implementation, a rotary cutter may comprise a leveling system and may further comprise a center cutting portion, a first cutting wing pivotally coupled to the center cutting portion, a second cutting wing pivotally coupled to the center cutting portion, and an actuator system. The actuator system may comprise a center leveling sub-system, a first wing leveling sub-system, and a second wing leveling sub-system. The respective leveling sub-systems may comprise a mount coupled to the respective center cutting portion, first cutting wing and second cutting wing, an actuator having a first end pivotally coupled to the mount and a second end comprising a piston rod operably, threadably received by a clevis. The clevis may be pivotally coupled to a deck support system configured to operably engage a surface beneath the respective center cutting portion, first cutting wing, and second cutting wing. The respective leveling sub-systems may be configured such that rotating the piston rod may adjust a distance between the first end of the respective actuator and the respective clevis and may result in an adjustment to a height of the respective center cutting portion, first cutting wing and second cutting wing relative to the surface.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a component diagram illustrating a perspective view of a rotary cutter having a leveling system according to an implementation.

FIG. 2 is a component diagram illustrating a top view of a rotary cutter having a leveling system according to an implementation.

FIG. 3 is a component diagram illustrating a perspective view of a rotary cutter having a leveling system and a wing actuating system according to an implementation.

FIG. 4 is a component diagram illustrating a rear perspective view of a center leveling sub-system of a rotary cutter having a leveling system according to an implementation.

FIG. 5 is a component diagram illustrating a front perspective view of a center leveling sub-system of a rotary cutter having a leveling system according to an implementation.

FIG. 6 is a component diagram illustrating rear perspective view of a first wing leveling sub-system of a rotary cutter having a leveling system according to an implementation.

FIG. 7 is a component diagram illustrating front perspective view of a first wing leveling sub-system of a rotary cutter having a leveling system according to an implementation.

FIG. 8 is a component diagram illustrating left side view of a first wing leveling sub-system of a rotary cutter having a leveling system according to an implementation.

FIG. 9 is a component diagram illustrating a rear perspective view of a second wing leveling sub-system of a rotary cutter having a leveling system according to an implementation.

FIG. 10 is a component diagram illustrating front perspective view of a second wing leveling sub-system of a rotary cutter having a leveling system according to an implementation.

FIG. 11 is a component diagram illustrating right side view of a second wing leveling sub-system of a rotary cutter having a leveling system according to an implementation.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, may be suitable for use in different rotary cutters and agricultural and agrarian applications requiring a particular clearance above the ground. That is, the herein disclosed examples can be implemented in different agricultural equipment other than for clearing particular types of grasses, crops, and/or other vegetation (e.g., other than for specific field clearing equipment for particular cutting applications, such as the herein described rotary cutter).

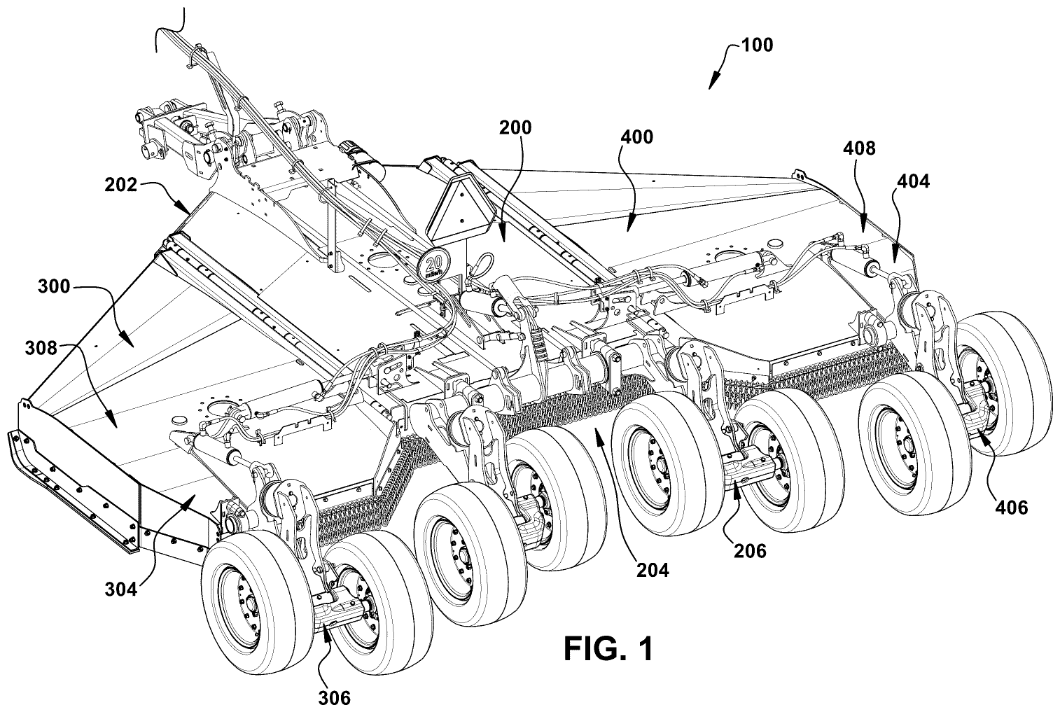

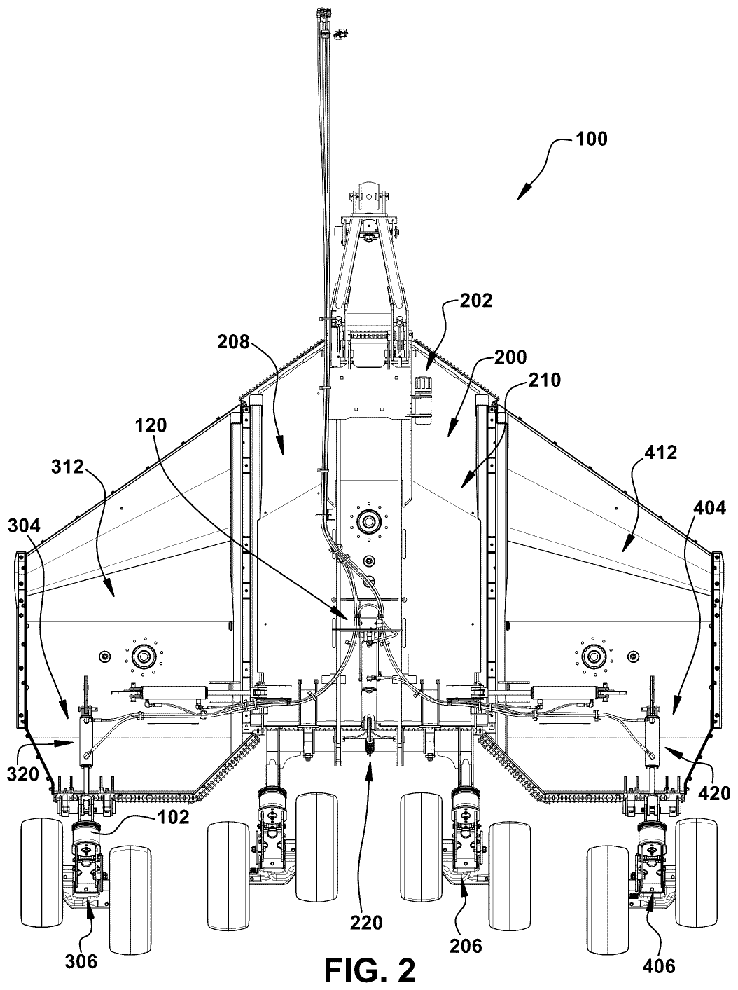

FIGS. 1 and 2 illustrate an example rotary cutter 100 that can utilize one or more portions of the aspects and examples described herein to level a piece of equipment above a surface, such as the ground. In this example, the rotary cutter 100 is a flex wing rotary cutter, but other types of rotary cutters are contemplated by this disclosure.

The rotary cutter 100 includes a center portion 200 being a center cutting portion having a front end 202 configured to be mounted to a tractor or other mechanism having towing capabilities (not shown) and a back end 204 supported by at least one deck support system 206, such as a wheel system. The rotary cutter 100 also includes a first wing 300 being a first cutting wing pivotally coupled to a first side 208 of the center portion 200 and a second wing 400 being a second cutting wing pivotally coupled to a second end 210 of the center portion 200. The first wing 300 is supported by the center portion 200 on one side, and by a second deck support system 306 (e.g., a second wheel system) at a back end 304 of the first wing 300. The second wing 400 is supported by the center portion 200 on one side, and by a third deck support system 406 (e.g., a third wheel system) at a back end 404 of the second wing 400. It will be appreciated that the rotary cutter 100 may comprise any number of cutting wings and corresponding deck support system. For example, in one implementation, may comprise a center cutting portion, a first cutting wing pivotally coupled to the center cutting portion, a second cutting wing pivotally coupled to the center cutting portion, a third cutting wing pivotally coupled to the first cutting wing, and a fourth cutting wing pivotally coupled to the second cutting wing.

Each deck support system 206,306,406 includes a suspension element 102 to provide dampening of the rotary cutter 100 as it passes through a field or other uneven surface. The dampening provides improved ride quality and operator comfort, increases the life of the rotary cutter, and enables a more consistent and level cut. In one implementation the suspension element 102 can comprise a foam urethane suspension element having a plurality of conjoined disks capable of compressing and reforming. It will be appreciated that the suspension element 102 may be any suitable suspension mechanism, for example, metallic springs, rubber springs, air suspension systems, etc.

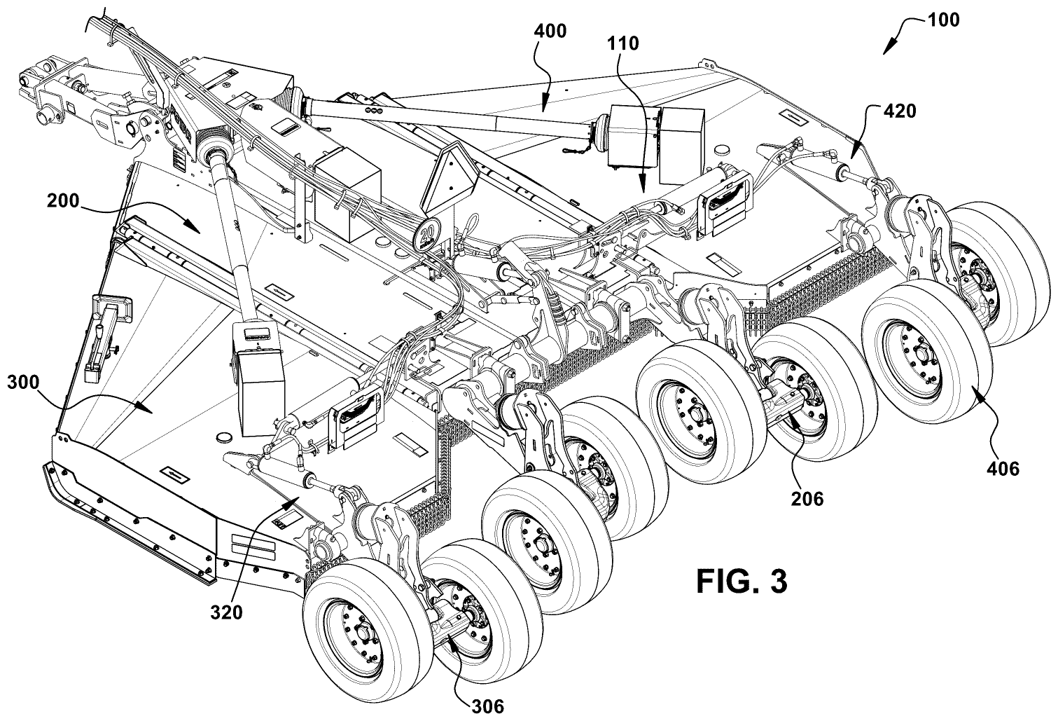

As shown in FIG. 3, the rotary cutter 100 is configured to utilize a wing actuating system 110 to operably pivot the first wing 300 and the second wing 400 between the first upright position and the second extended position. By enabling a first upright position and a second extended position, an operator of the rotary cutter 100 may easily transport the rotary cutter 100 in the more narrow, upright position while retaining the efficient cutting capabilities when in the wider, extended position. In the illustrated example, the wing actuating system 110 is a hydraulic piston system. It will be appreciated that the wing actuating system 110 may utilize any suitable actuators or piston types capable of pivoting the first wing 300 and the second wing 400 between a first upright position and a second extended position. For example, the wing actuating system 110 may alternatively be pneumatic, electrical, electromechanical, etc.

The rotary cutter 100 includes an actuator system 120 configured to operably adjust the height of the center portion 200, the first wing 300, and the second wing 400 between a first raised position and a second lowered position such that the first wing 300 and the second wing 400 move relative to the center portion 200. By enabling the center portion 200, first wing 300 and second wing 400 to be raised and lowered relative to a surface, such as the ground, a user is able to cut a field or pasture to a predetermined level. This predetermined level may be based on the wetness of a field or pasture, the thickness of the grass or crop or brush being cut, a desired aesthetic height, etc. In the illustrated example, the actuator system 120 is a hydraulic piston system. It will be appreciated that the actuator system 120 may utilize any suitable actuator or piston types capable of adjusting the height of the center portion 200, the first wing 300, and the second wing 400 between a first raised position and a second lowered position. For example, the actuator system 120 may alternatively be pneumatic, electrical, electromechanical, etc.

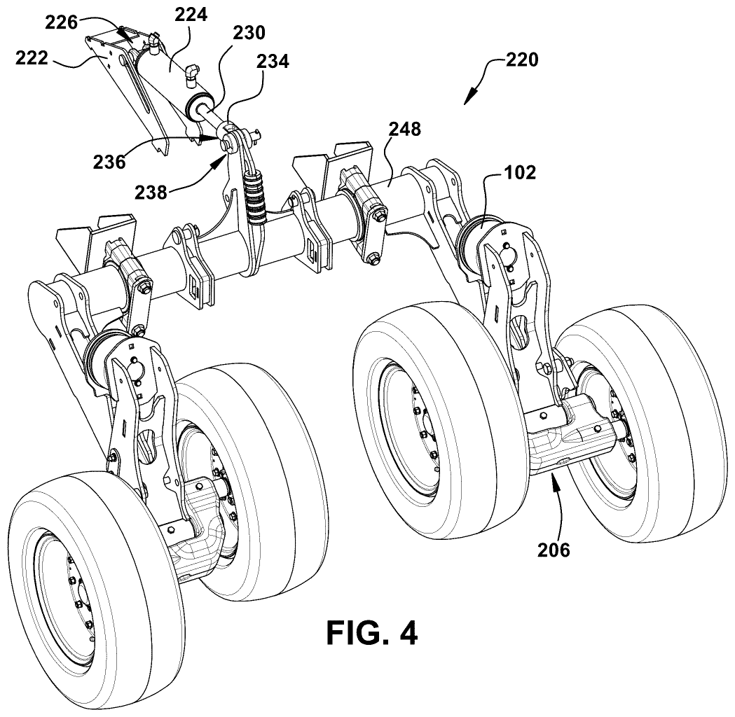

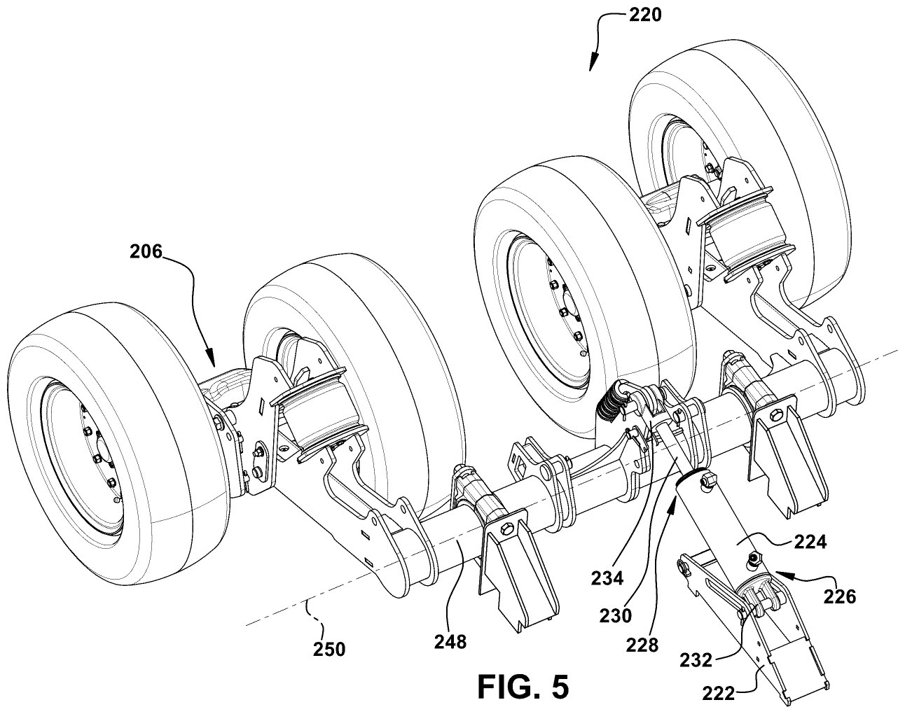

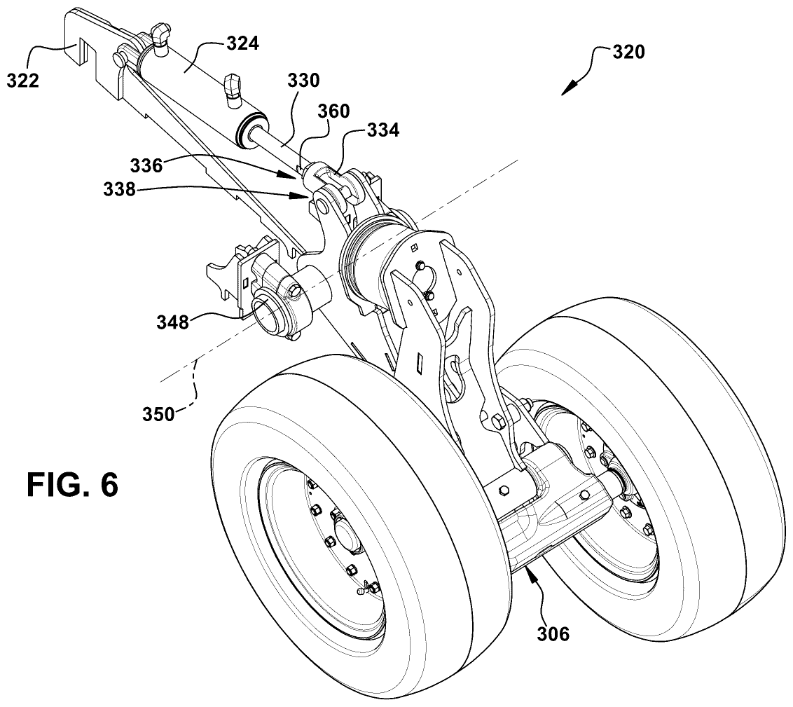

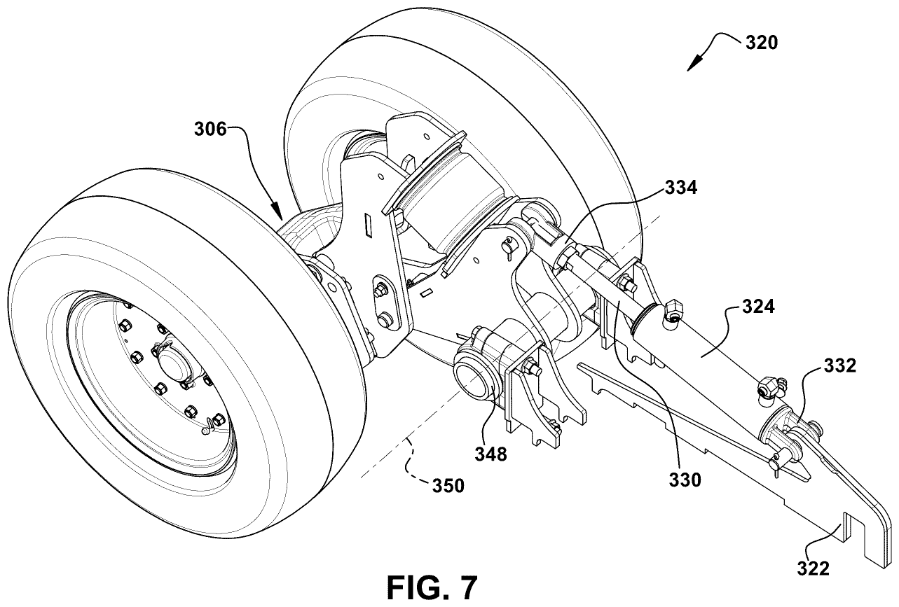

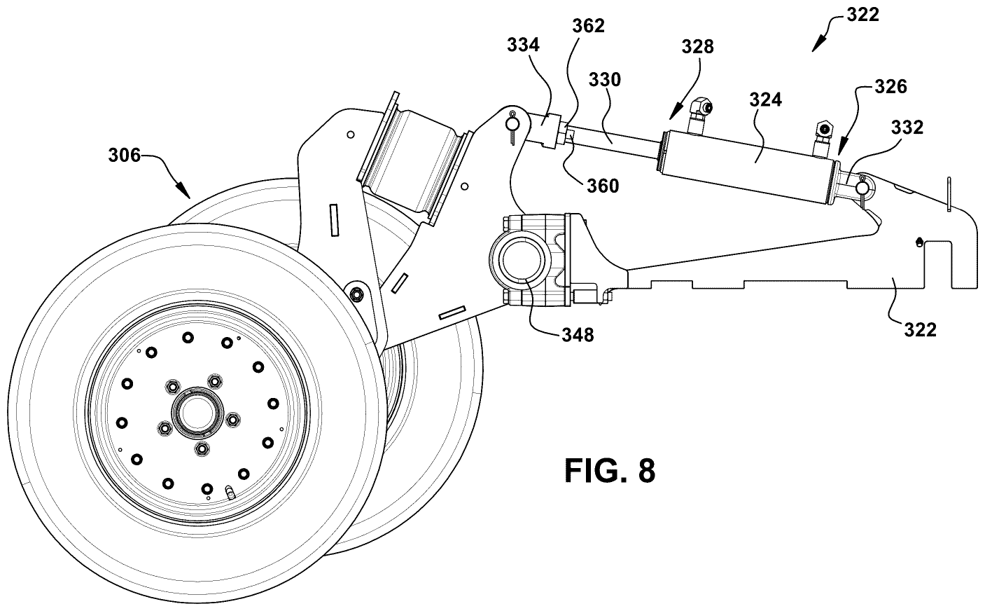

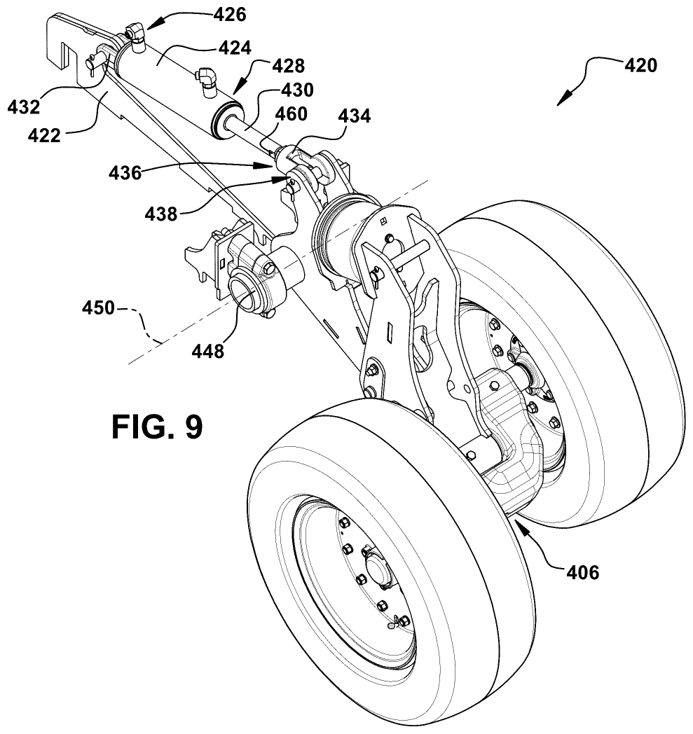

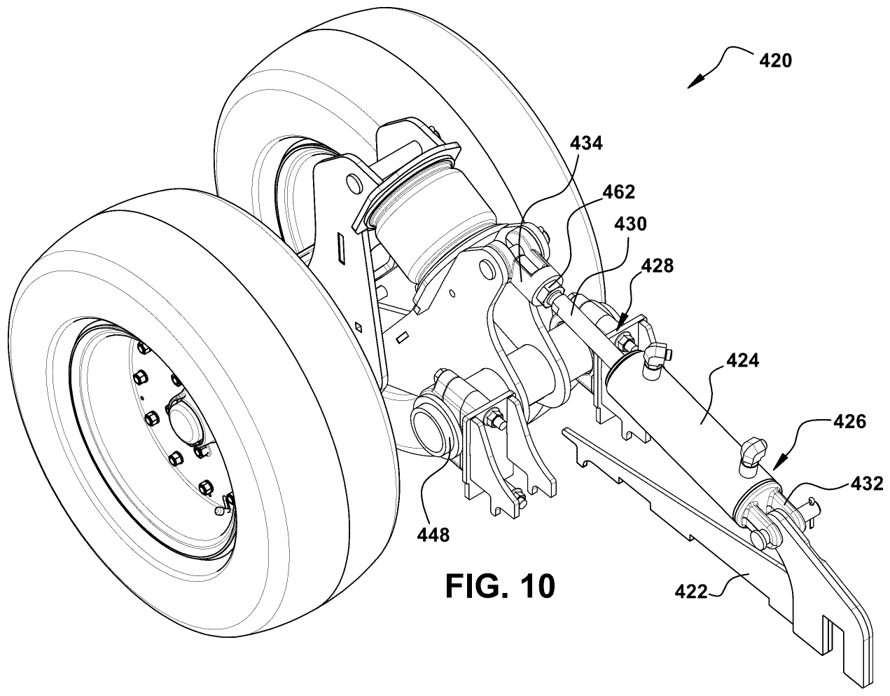

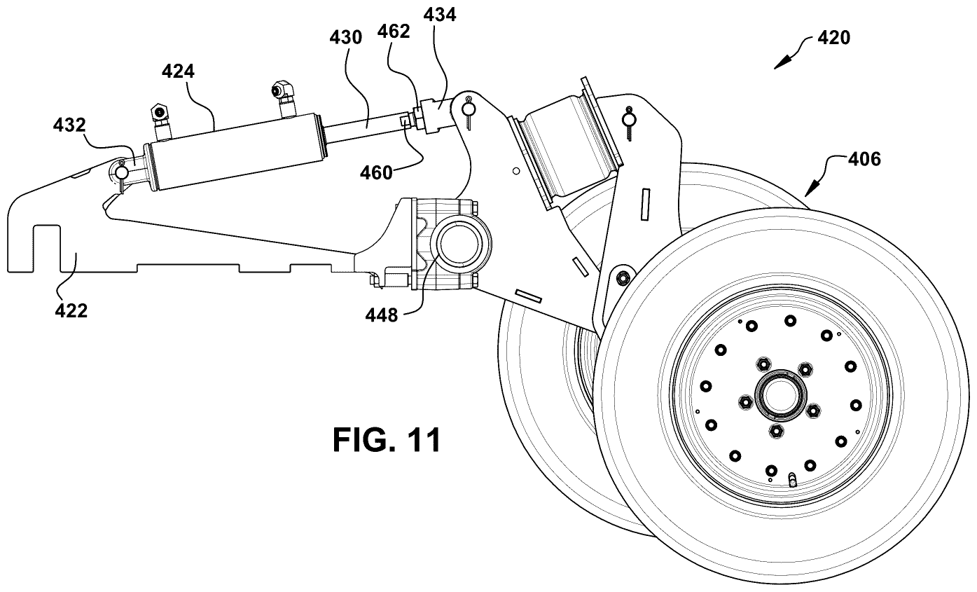

Turning now to FIGS. 4-11, the actuator system 120 will be described in detail herein. To adjust the height of the center portion 200, the first wing 300, and the second wing 400 between a first raised position and a second lowered position, the actuator system 120 includes a center leveling sub-system 220, a first wing leveling sub-system 320, and a second wing leveling sub-system 420 each connected to the respective deck support system 206,306,406. The actuator system 120 is capable of simultaneously actuating each leveling sub-system 220,320,420 to engage the respective deck support system 206,306,406, thereby adjusting the height of the first wing 300 and the second wing 400 relative to the center portion 200.

To effectuate the height adjustment of each of the center portion 200, first wing 300, and second wing 400, each of the leveling sub-systems 220,320,420 includes an actuator 224,324,424 having a first end 226,326,426 configured to be pivotally coupled to a mount 222,322,422, the mount being positioned proximate the back end 204,304,404 of the respective center portion 200, first wing 300, or second wing 400. In the illustrated example, each mount 222,322,422 is a single projecting member or a pair of spaced projecting members extending from the respective center portion 200, first wing 300, or second wing 400. It will be appreciated that each mount 222,322,422 may be any suitable shape capable of securing the actuator 224,324,424 to the respective center portion 200, first wing 300, or second wing 400.

To pivotally couple each actuator 224,324,424 to its respective mount 222,322,422, the first end 226,326,426 of each actuator 224,324,424 may comprise a pin style mount, such as using a pair of spaced projections 232,332,432 extending therefrom, the pair of spaced projections 232,332,432 having an opening extending therethrough. The openings of the pair of spaced projections 232,332,432 are aligned with an opening extending through the respective mount 222,322,422 such that a pin or rod may be inserted therethrough and secured in place (e.g., with a fastener, clip, pin, etc.). It will be appreciated that the actuator 224,324,424 of each leveling sub-system 220,320,420 may be pivotally coupled to the respective mount 222,322,422 by any suitable means, for example, a hinge system, pivot joints, etc. By pivotally coupling each actuator 224,324,424 to the respective mount 222,322,422, each actuator 224,324,424 is able to pivot to accommodate for the actuation of the respective leveling system 220,320,420.

Each actuator 224,324,424 further includes a second end 228,328,428 comprising a piston rod 230,330,430 configured to be selectably coupled to a respective clevis 234,334,434. In an implementation, the engagement end of each piston rod 230,330,430 is threaded (e.g., comprising external threading) and configured to be threadably coupled to the respective clevis 234,334,434, which comprises complementary threading configured to receive the threading of the piston rod 230,330,430 (e.g., comprising a via with internal, complementary threading).

Each clevis 234,334,434 has a first end 236,336,436 configured to receive the respective piston rod 230,330,430 and a second end 238,338,438 configured to be pivotally coupled to the respective deck support system 206,306,406. It will be appreciated that each clevis 234,334,434 may be any suitable clevis type or shape capable of receiving a piston rod 230,330,430 and being pivotally coupled to a deck support system 206,306,406, for example, a rod clevis, a hanger clevis, etc. In the illustrated example, each clevis 234,334,434 is a rod clevis including a base having a threaded (e.g., comprising internal threading) opening/via therethrough and a pair of spaced projections extending therefrom each having an opening. In the same example, the threaded opening is configured to threadably receive a respective piston rod 230,330,430 having complementary threading, and the openings of the spaced projections are configured such that a rod may be inserted therethrough and secured with a pin.

Upon actuating the actuator system 120, the actuator 224,324,424 of each leveling sub-system 220,320,420 simultaneously actuates causing each piston rod 230,330,430 to be extended from or withdrawn into its respective actuator 224,324,424, comprising a primary adjustment of the deck. The displacement of the piston rod 230,330,430 is translated to each clevis 234,334,434, thereby changing a distance between the first end 226,326,426 of the actuator 224,324,424 and the clevis 234,334,434 and displacing each deck support system 206,306,406. In the illustrated example, the outward displacement of each piston rod 230,330,430 increases a distance between the first end 226,326,426 of the actuator 224,324,424 and the clevis 234,334,434 causing each deck support system 206,306,406 to pivot clockwise about a fulcrum 248,348,448 defining an axis 250,350,450, thereby engaging a surface (e.g., ground) to raise each of the center portion 200, first wing 300 and second wing 400 relative to the surface. Inversely, the inward displacement of each piston rod 230,330,430 decreases a distance between the first end 226,326,426 of the actuator 224,324,424 and the clevis 234,334,434 causing each deck support system 206,306,406 to pivot counterclockwise about a fulcrum 248,348,448 and lower each of the center portion 200, first wing 300 and second wing 400 relative to the surface.

In addition to moving relative to the center portion 200, the first wing 300 and second wing 400 are configured to have a secondary adjustment, such as to move independently from the center portion 200 and the opposite wing. To enable the secondary adjustment of each of the first wing 300 and second wing 400, the first wing and second wing leveling sub-systems 320,420 can be used to help further align/level the first wing 300 and the second wing 400 with respect to the center portion 200. By enabling each wing 300,400 to be further aligned/leveled with respect to the center portion 200, a user can attempt to provide a level cut when using the rotary cutter 100.

The first wing leveling sub-system 320 is further configured to operably adjust the height of the first wing 300 using the independent, secondary adjustment from the center portion 200 and the second wing 400. The piston rod 330 of the first wing leveling sub-system 320 may include a tool surface 360 to accept a tool for rotation and a fastener 362 positioned on the piston rod 330 between the first end 326 of the actuator 324 and clevis 334. In an implementation, the fastener 362 may be configured to be threadably coupled to the piston rod 330 such that the fastener 362 may be moved along at least a portion of a length of the piston rod 330. The fastener 362 is configured such that when the fastener 362 is positioned to abut the clevis 334, the portion of the piston rod 330 received by the clevis 334 is operably, fixedly secured within the clevis 334 to mitigate rotation of the rod 330 during use. The fastener 362 may be any suitable fastener capable of being threadably coupled to a threaded rod, for example, a nut, a jam nut, a stop nut, etc.

The second wing leveling sub-system 420 is further configured to operably adjust the height of the second wing 400 using the independent, secondary adjustment from the center portion 200 and the first wing 300. The piston rod 430 of the second wing leveling sub-system 420 may include a tool surface 460 to accept a tool for rotation and a fastener 462 positioned on the piston rod 430 between the first end 426 of the actuator 424 and clevis 434. In an implementation, the fastener 462 may be threadedly coupled to the piston rod 430 such that the fastener 462 may be moved along at least a portion of a length of the piston rod 430. The fastener 462 is configured such that when the fastener 462 is positioned to abut the clevis 434, the portion of the piston rod 430 threadedly received by the clevis 434 is operably, fixedly secured within the clevis 434 to mitigate rotation of the rod 430 during use. The fastener 462 may be any suitable fastener capable of being threadably coupled to a threaded rod, for example, a nut, a jam nut, a stop nut, etc.

To operably adjust the height of the first wing 300 independent from the center portion 200 and the second wing 400, a user may adjust the distance between the first end 326 of the actuator 324 and the clevis 334 of the first wing sub-leveling system 320 by adjusting the length of the piston rod 330 threadably received by the clevis 334. First, a user may rotate the fastener 362 such that the fastener 362 is threadably translated away from the clevis 334 to allow the piston rod 330 to be rotated relative to the clevis 334. The user may then rotate the piston rod 330 with a tool via the tool surface 360, thereby causing the piston rod 330 to threadably translate further into or out of the first end 336 of the clevis 334 without adjusting the position of the piston rod 330 within the actuator 324.

Similar to the actuation of the actuator 324 of the first wing leveling sub-system 320, adjusting the distance between the first end 326 of the actuator 324 and the clevis 334 displaces the deck support system 306 of the first wing 300. As explained above, displacing the deck support system 306 causes the deck support system 306 to rotate about a fulcrum 348, thereby adjusting the height of the first wing 300 with respect to the surface. In an implementation, threadably translating the piston rod 330 away from the clevis 334 increases the distance between the first end 326 of the actuator 324 and the clevis 334, causing the deck support system 306 to rotate clockwise, thereby raising the first wing 300 away from the surface. Inversely, threadably translating the piston rod 330 toward the clevis 334 decreases the distance between the first end 326 of the actuator 324 and the clevis 334, causing the deck support system 306 to rotate counterclockwise, thereby lowering the first wing 300 toward the surface. After the first wing 300 is positioned at a desired height, a user may rotate the fastener 362 to abut the clevis 334 and secure the position of the piston rod 330 in relation to the clevis 334. It will be appreciated that a user may first translate the fastener 362 away from the clevis 334 to enable the rotation of the piston rod 330 in relation to the clevis 334.

To operably adjust the height of the second wing 400 independent from the center portion 200 and the first wing 300, a user may adjust the distance between the first end 426 of the actuator 424 and the clevis 434 of the second wing sub-leveling system 420 by adjusting the length of the piston rod 430 threadably received by the clevis 434. First, a user may rotate the fastener 462 such that the fastener 462 is threadably translated away from the clevis 434 to allow the piston rod 430 to be rotated relative to the clevis 434. The user may then rotate the piston rod 430 with a tool via the tool surface 460, thereby causing the piston rod 430 to threadably translate further into or out of the first end 436 of the clevis 434 without adjusting the position of the piston rod 430 within the actuator 424.

Similar to the actuation of the actuator 424 of the second wing leveling sub-system 420, adjusting the distance between the first end 426 of the actuator 424 and the clevis 434 displaces the deck support system 406 of the second wing 400. As explained above, displacing the deck support system 406 causes the deck support system 406 to rotate about a fulcrum 448, thereby adjusting the height of the second wing 400 with respect to the surface. In an implementation, threadably translating the piston rod 430 away from the clevis 434 increases the distance between the first end 426 of the actuator 424 and the clevis 434, causing the deck support system 406 to rotate clockwise, thereby raising the second wing 400 away from the surface. Inversely, threadably translating the piston rod 430 toward the clevis 434 decreases the distance between the first end 426 of the actuator 424 and the clevis 434, causing the deck support system 406 to rotate counterclockwise, thereby lowering the second wing 400 toward the surface. After the second wing 400 is positioned at a desired height, a user may rotate the fastener 462 to abut the clevis 434 and secure the position of the piston rod 430 in relation to the clevis 434. It will be appreciated that a user may first translate the fastener 462 away from the clevis 434 to enable the rotation of the piston rod 430 in relation to the clevis 434.

The first wing leveling sub-system 320 may be positioned on a top 312 of the first wing 300 proximate a first side 308 of the first wing 300. By positioning the first wing leveling sub-system 320 on the top 312 of the first wing 300 proximate the first side 308, the tool surface 360 and fastener 362 of the first wing leveling sub-system 320 are easily accessible to a user. The first wing leveling sub-system 320 being easily accessible to a user allows for easy leveling of the first wing 300, such as by allowing easier access for use of tools with the sub-system 320, where needed.

The second wing leveling sub-system 420 may be positioned on a top 412 of the second wing 400 proximate a first side 408 of the second wing 400. By positioning the second wing leveling sub-system 420 on the top 412 of the second wing 400 proximate the first side 408, the tool surface 460 and fastener 462 of the second wing leveling sub-system 420 are easily accessible to a user. The second wing leveling sub-system 420 being easily accessible to a user allows for easy leveling of the second wing 400, such as by allowing easier access for use of tools with the sub-system 420, where needed.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A leveling system for a rotary cutter, the rotary cutter comprising:
a center cutting portion;
a first cutting wing pivotally coupled to the center cutting portion;
a second cutting wing pivotally coupled to the center cutting portion; and
an actuator system comprising a center leveling sub-system, a first wing leveling sub-system, and a second wing leveling sub-system, the respective leveling sub-systems comprising an actuator having a first end pivotally coupled to the respective center cutting portion, first cutting wing, and second cutting wing, and a second end threadably received by a deck support system configured to operably engage a surface beneath the center cutting portion, first cutting wing, and second cutting wing, wherein adjusting a distance between the first end of the actuator and the deck support system results in an adjustment to a height of the respective center cutting portion, first cutting wing and second cutting wing relative to the surface;
the actuator system being configured to operably adjust the height of the center cutting portion, the first cutting wing, and the second cutting wing between a first raised position and a second lowered position such that the first cutting wing and the second cutting wing move relative to the center cutting portion;
wherein rotating the second end of the actuator of the first wing leveling sub-system results in an adjustment to the height of the first cutting wing independent from the center cutting portion and the second cutting wing; and
wherein rotating the second end of the actuator of the second wing leveling sub-system results in an adjustment to the height of the second cutting wing independent from the center cutting portion and the first cutting wing.

2. The leveling system according to claim 1 further comprising a third cutting wing pivotally coupled to the first cutting wing, and a fourth cutting wing pivotally coupled to the second cutting wing.

3. The leveling system according to claim 2, wherein the third cutting wing is pivotally coupled to the first cutting wing at an end of the first cutting wing opposite the center cutting portion, and the fourth cutting wing is pivotally coupled to the second cutting wing at an end of the second cutting wing opposite the center cutting portion.

4. The leveling system according to claim 2, wherein the actuator system further comprises a third wing leveling sub-system and a fourth wing leveling sub-system, the respective leveling sub-systems comprising an actuator comprising a first end pivotally coupled to the respective third cutting wing and fourth cutting wing, and a second end threadably received by a deck support system that operably engages a surface beneath the third cutting wing and fourth cutting wing, wherein adjusting a distance between the first end of the actuator and the deck support system results in an adjustment to a height of the respective third cutting wing and fourth cutting wing relative to the surface.

5. The leveling system according to claim 1 wherein the center cutting portion, first cutting wing, and second cutting wing further comprise a fulcrum about which the respective deck support system pivots.

6. The leveling system according to claim 1, wherein the second end of the actuator of the respective leveling sub-systems comprises a piston rod.

7. The leveling system according to claim 6 wherein the respective deck support systems comprise a clevis comprising a first end configured to threadably receive the second end of the respective actuator and a second end configured to be pivotally coupled to the respective deck support system.

8. The leveling system according to claim 7, wherein the piston rod of the respective first and second wing leveling sub-systems comprises external threading and the respective clevis comprises an opening with complementary internal threading such that when the piston rod is engaged with the clevis and rotated, the piston rod is translated with respect to the clevis.

9. The leveling system according to claim 8, wherein rotating the piston rod of the respective first and second wing leveling sub-system in a first direction increases the distance between the first end of the actuator and the clevis, resulting in an increase in distance between the respective first wing and second wing and the surface.

10. The leveling system according to claim 8, wherein the first and second wing leveling sub-systems further comprise a fastener threadably coupled to the piston rod, the fastener being positioned on the piston rod proximate the clevis.

11. The leveling system according to claim 8, wherein the piston rod comprises a tool surface sized and shaped to receive a tool that is capable of rotating the piston rod with respect to the actuator.

12. The leveling system according to claim 1, wherein the actuator of the respective leveling sub-systems comprises one or more of:
a hydraulic actuator;
a pneumatic actuator;
an electrical actuator; and
an electromechanical actuator.

13. The leveling system according to claim 1, wherein the respective leveling sub-systems further comprise a suspension element.

14. The leveling system according to claim 13, wherein the suspension element of the respective leveling sub-systems is a foam urethane suspension element comprising a plurality of conjoined disks.

15. A leveling system for a rotary cutter, the rotary cutter comprising:
a center cutting portion comprising a first side and a second side;
a first cutting wing pivotally coupled to the first side of the center cutting portion, the first cutting wing comprising a first side opposite the center cutting portion;
a second cutting wing pivotally coupled to the second side of the center cutting portion, the second cutting wing comprising a first side opposite the center cutting portion; and
an actuator system comprising a center leveling sub-system, a first wing leveling sub-system positioned proximate the first side of the first cutting wing, and a second wing leveling sub-system positioned proximate the first side of the second cutting wing, the respective leveling sub-systems comprising an actuator having a first end pivotally coupled to the respective center cutting portion, first cutting wing, and second cutting wing, and a second end threadably received by a deck support system configured to operably engage a surface beneath the respective center cutting portion, first cutting wing, and second cutting wing, wherein adjusting a distance between the first end of the actuator and the deck support system results in an adjustment to a height of the respective center cutting portion, first cutting wing, and second cutting wing relative to the surface;
the actuator system being configured to operably adjust the height of the center cutting portion, the first cutting wing, and the second cutting wing between a first raised position and a second lowered position such that the first cutting wing and the second cutting wing move relative to the center cutting portion;
wherein rotating the second end of the actuator of the first wing leveling sub-system results in an adjustment to the height of the first cutting wing independent from the center cutting portion and the second cutting wing; and
wherein rotating the second end of the actuator of the second wing leveling sub-system results in an adjustment to the height of the second cutting wing independent from the center cutting portion and the first cutting wing.

16. The leveling system according to claim 15, wherein the second end of the actuator of the respective leveling sub-systems comprises a piston rod.

17. The leveling system according to claim 16, wherein the piston rod of the respective wing leveling sub-systems comprises external threading and the respective deck support system comprises a clevis comprising an opening with complementary internal threading, such that when the piston rod is engaged with the clevis and rotated, the piston rod is translated with respect to the clevis.

18. The leveling system according to claim 17, wherein rotating the piston rod of the respective wing leveling sub-systems in a first direction increases the distance between the first end of the actuator and the clevis, resulting in an increase in distance between the respective wing and the surface.

19. The leveling system according to claim 17, the piston rod comprising a tool surface sized and shaped to receive a tool that is capable of rotating the piston rod with respect to the actuator.

20. A leveling system for a rotary cutter, the rotary cutter comprising:
a center cutting portion;
a first cutting wing pivotally coupled to the center cutting portion;
a second cutting wing pivotally coupled to the center cutting portion; and
an actuator system having a center leveling sub-system, a first wing leveling sub-system, and a second wing leveling sub-system, the respective leveling sub-systems including a mount coupled to the respective center cutting portion, first cutting wing and second cutting wing, an actuator having a first end pivotally coupled to the mount and a second end comprising a piston rod operably, threadably received by a clevis, the clevis being pivotally coupled to a deck support system configured to operably engage a surface beneath the respective center cutting portion, first cutting wing, and second cutting wing, wherein rotating the piston rod adjusts a distance between the first end of the respective actuator and the respective clevis and results in an adjustment to a height of the respective center cutting portion, first cutting wing and second cutting wing relative to the surface;
the actuator system being configured to operably adjust the height of the center cutting portion, the first cutting wing, and the second cutting wing between a first raised position and a second lowered position such that the first cutting wing and the second cutting wing move relative to the center cutting portion;
wherein rotating the piston rod of the first wing leveling sub-system results in an adjustment to the height of the first cutting wing independent from the center cutting portion and the second cutting wing; and
wherein rotating the piston rod of the second wing leveling sub-system results in an adjustment to the height of the second cutting wing independent from the center cutting portion and the first cutting wing.
